(19) United States
(12) Patent Application Publication
(10) Pub. No.: US 2013/0104345 A1
(43) Pub. Date: May 2, 2013

(54) HINGE WITH INTEGRAL STOP

(71) Applicant: ROBERT J. GRANBERRY, Houston, TX (US)

(72) Inventor: ROBERT J. GRANBERRY, Houston, TX (US)

(21) Appl. No.: 13/287,312

(22) Filed: Nov. 2, 2011

(51) Int. Cl. E05D 11/06

(52) U.S. Cl. 16/374

(57) ABSTRACT

A door hinge (10) with an integral door stop (20) is provided for limiting pivoting motion of the door when in the open position. A planar door hinge plate (12) is secured to a door, while frame hinge plate (14) is secured to a door frame. A plurality of door hinge knuckles (22) and frame hinge knuckles (24) are each secured to a respective door hinge plate and frame hinge plate, and hinge pin (26) passes through an opening in each of the knuckles. A door stop (20) has an opening (34) to receive a hinge pin, and has a first planar surface (28) for engagement with the door hinge plate when the door is open and a second planar surface (30) for engagement with the frame hinge plate when the door is open.

### FIELD OF THE INVENTION

The present invention relates to a stop to that limits the pivoting motion of a door. More particularly, the present invention relates to an improved door hinge with an integral stop.

### BACKGROUND OF THE INVENTION

Various types of door stops have been devised, including wall-mounted stops intended to engage a door handle, and floor or wall-mounted stops intended to engage an open door. While these stops may serve their intended function for a period of time, the stops are generally considered unsightly, and floor-mounted stops may constitute a tripping hazard. These types of stops also have very limited adjustment, and the fully open door is substantially perpendicular to the fully closed door. Due to the momentum of the swinging door, these stops frequently become damaged during use, and a stop may become loose or break free from the wall or floor mount, creating a further unsightly appearance.

Various techniques have been devised to incorporate a door stop and a hinge. A rather complex, non-standard hinge is disclosed in U.S. Pat. No. 4,949,427, with the hinge having an integral detent and stop. Another version of a door stop incorporated into a hinge is disclosed in U.S. Pat. No. 6,427,287. Again this mechanism is awkward and does not utilize a conventional door hinge. U.S. Pat. No. 6,012,281 discloses yet another version of a door hinge with camming surfaces and a compression spring. U.S. Pat. No. 6,477,738 discloses a door stop with a demountable door hinge, and U.S. Pat. No. 6,701,576 discloses another version of a door hinge with a spring mechanism and an integrated door stop. A door hinge with integrated door stop is also disclosed in U.S. Pat. No. 6,739,020. Application 2010/0269302 discloses a door hinge with a pair of protrusions each secured to hinge plate and extending radially outward from the hinge plate, with plastic or rubber sleeves optionally covering the protrusions. U.S. Publication 2009/0211054 discloses a door hinge with a stop mechanism with a modified second door hinge side which is not mounted to the frame of the building.

While the above door stops avoid some of the problems associated with the conventional doorstop, each of these references creates additional problems in that the modified door hinge is also unsightly. As disclosed in the above patents and publications, these door hinge and stop assemblies are frequently complex and thus expensive, with numerous movable parts required to achieve door operation. Prior art stops may break or damage the door trim or wall material, i.e., sheetrock. Prior art stops are also complex with many parts that create unreliability and adjustment that can slip.

The disadvantages of the prior art are overcome by the present invention, an improved hinge with an integral stop is hereinafter disclosed.

### SUMMARY OF THE INVENTION

In one embodiment, a door hinge is provided with an integral door stop for limiting pivoting movement of a door when in the open position. The door hinge comprises a substantially planar door hinge plate secured to the door, and a similar frame hinge plate secured to a door frame. A plurality of door hinge knuckles are secured to the door hinge plate, and a plurality of frame hinge knuckles are secured to the frame hinge plate. A hinge pin passes through apertures provided in each of the plurality of door hinge knuckles and the plurality of frame hinge knuckles. A door stop has a through opening to receive the hinge pin, and has a first planar surface for engagement with the planar door hinge plate when the door is open, and a second planar surface spaced circumferential from the first surface for engagement with the frame hinge plate when the door is open.

These and further features and advantages of the present invention will become apparent from the following detailed description, wherein reference is made to the figures in the accompanying drawings.

### BRIEF DESCRIPTION OF THE DRAWINGS

FIG. 1 is a perspective view of the one embodiment of a door hinge according to the present invention.

FIG. 2 is an exploded view of the door hinge shown in FIG. 1.

FIG. 3 is a perspective view of the door hinge stop.

FIG. 4 is a top view of the door hinge shown in FIG. 1.

FIG. 5 is a top view of the door hinge in the closed position.

FIG. 6 is an exploded view of an alternative hinge stop.

### DETAILED DESCRIPTION OF PREFERRED EMBODIMENTS

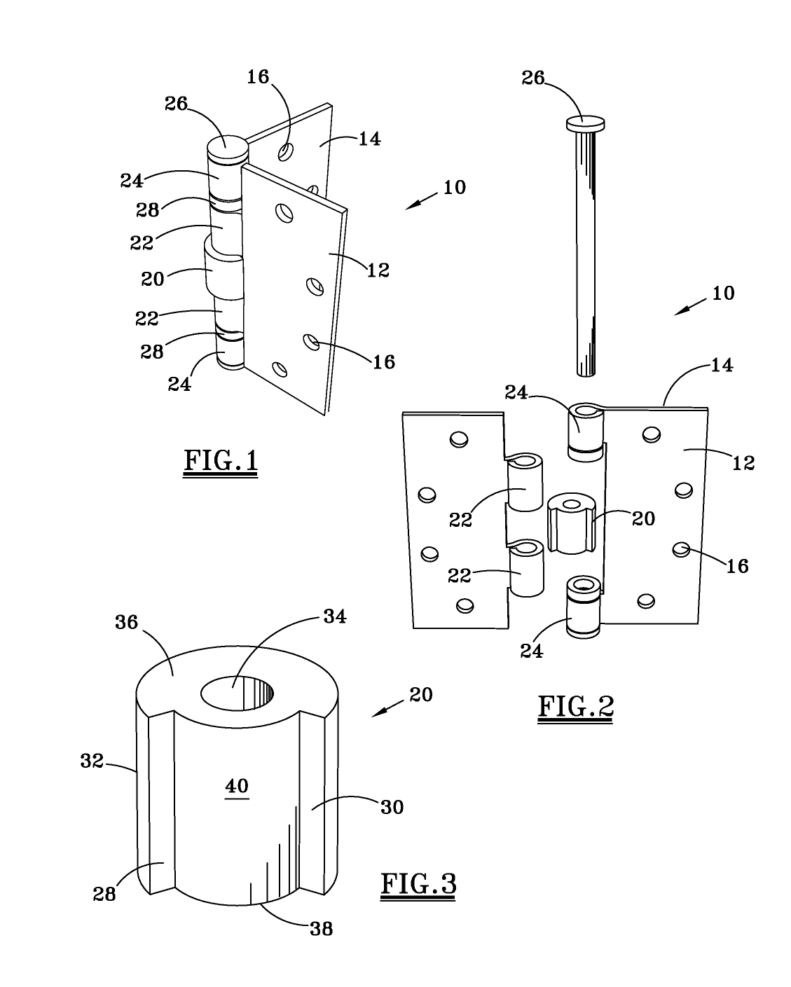

FIG. 1 discloses a door hinge 10 according to the present invention with an integral stop 20. The door hinge is substantially similar to prior art hinges with no stop, and includes a substantially planar door hinge plate 12 which is secured to a door, and a similar substantially similar frame hinge plate 14 secured to a door frame. Each of plates 12 and 14 may contain a plurality of through apertures 16 for receiving screws or other conventional securing members to secure each plate to a respective door and door frame. A plurality of door hinge knuckles 22 are each secured to the plate 12, while another plurality of knuckles 24 are each secured to the plate 14. Each knuckle may be formed by curving into a circle a portion of the respective plate, thereby forming a knuckle. Alternatively, a circular knuckle may be welded or otherwise screwed to a respective plate. Each of these knuckles has a conventional through aperture for receiving a pin, with a pin head 26 shown in FIG. 1. Spacers 28 may be provided for spacing between the knuckles, or the spacers 28 may be part of an existing knuckle or bearings.

Those skilled in the art will appreciate that a door hinge is functionally and visually similar to existing door hinges without an integral stop. Knuckles 22 are preferably provided above and below the stop 20, while similarly knuckles 24 are also provided both above and below the stop 20.

FIG. 2 is a top view of the door hinge shown in FIG. 1, and illustrates a substantially planar surface 28 on the stop 20 for engaging plate 12 when the door is in the open position, and a similar surface 30 on the stop 20 for engaging plate 14 when the door is in the open position. FIG. 2 also illustrates that the integral stop has a substantially cylindrical or C-shaped outer configuration with an exterior cylindrical surface 32 is preferably no more than 70% greater and for many embodiments may be no more than 50% greater than the diameter of the knuckles. Also, the OD surface 32 of the stop 20 could be substantially the same the diameter as the OD of the central hinge barrels as long as the tangs on the hinge plates 12, 14 extend out to meet the stop surfaces of the stop 20.

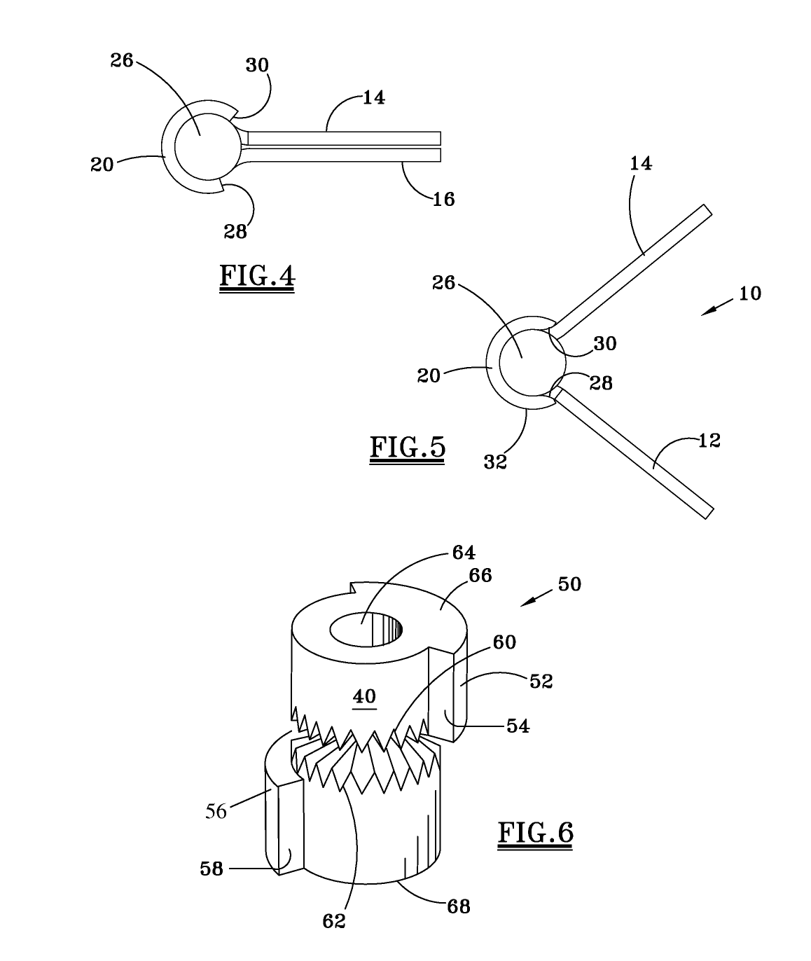

FIG. 3 illustrates the hinge 10 in a door-closed position, with the stop surfaces on the stop 20 being out of engagement with either of the plates 12 or 14. The stop surfaces 28 and 30 are also shown in FIG. 4 out of engagement with the plates 14 and 16.

FIG. 5 is a pictorial view of the stop 20, which includes a through aperture 34 for receiving a pin therein. Upper surface 36 of the stop 20 and lower surface 38 of the stop 20 are thus in planar engagement with the knuckles 22 above and below the stop when the hinge is in use. The knuckles thus limit movement of the stop 20 in a direction along on axis of the pin. FIG. 5 further illustrates that the stop includes the large diameter cylindrical surface 32 discussed above, and a smaller diameter surface 40 which may have a diameter approximating the diameter of the knuckles.

As shown in FIG. 5, the stop surfaces 28 and 30 are fixedly positioned on the stop 20, which may rotate with respect to the plates 12, 14, but are axially fixed in position by engagement with the knuckles above and below the stop 20. In the preferred embodiment, each of the surfaces 28, 30 are substantially planar surfaces intended for planar engagement with a respective plate, and each surface 28, 30 lies within a plane substantially parallel to an axis of the pin.

In an alternate embodiment, the diameter of the stop 20 may be reduced to approximate the diameter of the knuckles, so that the stop surfaces 28, 30 on the stop are at least partially radially inward of the knuckle diameter. In this case, an extension tab may be formed on each plate projecting inward from the otherwise inward plate edge as shown herein, so that the extension tab will engage the stop when the door is open.

In another embodiment, as shown in FIG. 6, the stop 50 has a two piece construction with teeth mating that allows the stop to be adjustable. The stop 50 would be held in place by the two barrels above and below the stop that capture the stop. The upper body 52 of the stop 50 has circumferentially arranged lower teeth 60 thereon, while the lower body 68 has circumferentially arranged upper teeth 62 thereon, with the teeth 60 and 62 mating when assembled on the hinge to provide a selected spacing between the stop surface 54 on the upper body 52 and the stop surface 58 on the lower body 56. Adjustable stop 50 includes a central through port 64 for receiving a pin 26, as previously described.

Receiving pin 26 may be pulled so that the stop 50 as shown in FIG. 6 may be slid laterally from between the barrels that engage the top surface 66 and the bottom surface 68 of the stop. Once removed, the upper body may be rotated relative to the lower body to adjust the circumferential position between stop surfaces 54 and 56, and thereby adjust the stop 50 to prohibit further opening of the door. The spacing of the teeth 60, 62 will thus determine the precise angular adjustment which may be achieved, but for most applications, an adjustment corresponding to the addition or subtraction of 5° of the door opening will satisfy a majority of customers.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A door hinge with an integral door stop for limiting pivoting motion of a door when in the open position, the door hinge comprising:
a substantially planar door hinge plate secured to the door;
a substantially planar frame hinge plate secured to a door frame;
a plurality of door hinge knuckles each secured to the door hinge plate;
a plurality of frame hinge knuckles each secured to the frame hinge plate;
a hinge pin passing through an opening in each of the plurality of door hinge knuckles and the frame hinge knuckles; and
a door stop having an opening therethrough to receive the hinge pin, the door stop having a first stop surface for engagement with the door hinge plate when the door is open and a second stop surface for engagement with the frame hinge plate when the door is open.

2. The door hinge as defined in claim 1, wherein each of the first planar surface and the second planar surface lie in a plane substantially parallel to an axis of the hinge pin.

3. The door hinge as defined in claim 1, wherein each of the door hinge plate and the frame hinge plate include a plurality of plate apertures for securing each plate to a respective door and door frame.

4. The door hinge as defined in claim 1, wherein the door stop is rotationally movable with respect to each of the door hinge plate and the door frame plate.

5. The door hinge as defined in claim 1, wherein movement of the door stop in a direction along an axis of the hinge pin is limited by the plurality of door hinge knuckles and frame hinge knuckles.

6. The door hinge as defined in claim 1, wherein the door stop comprises an upper body with lower teeth and a lower body with upper teeth, the mating teeth providing a selected circumferential spacing between the first stop surface and the second stop surface.

7. The door hinge as defined in claim 1, wherein each of the first stop surface and the second stop surface is fixedly positioned on the door stop.

8. A door hinge with an integral door stop for limiting pivoting motion of a door when in the open position, the door hinge comprising:
a door hinge plate for securing to the door;
a frame hinge plate for securing to a door frame;
at least one door hinge knuckle secured to the door hinge plate;
at least one hinge knuckle secured to the frame hinge plate;
a hinge pin passing through an opening in each of the at least one door hinge knuckle and frame hinge knuckle; and
a door stop having an opening therethrough to receive the hinge pin, the door stop having a first stop surface for engagement with the door hinge plate when the door is open and a second stop surface for engagement with the frame hinge plate when the door is open.

9. The door hinge as defined in claim 8, wherein each of the first stop surface and the second stop surface are substantially planar stop surfaces and each lie in a plane substantially parallel to an axis of the hinge pin.

10. The door hinge as defined in claim 8, wherein the door stop comprises an upper body with lower teeth and a lower body with upper teeth, the mating teeth providing a selected circumferential spacing between the first stop surface and the second stop surface.

11. The door hinge as defined in claim 8, wherein the door stop is rotationally movable with respect to each of the door hinge plate and the door frame plate.

12. The door hinge as defined in claim 8, wherein movement of the door stop in a direction along an axis the door pin is limited by the plurality of door hinge knuckles and frame hinge knuckles.

13. The door hinge as defined in claim 8, wherein each of the first stop surface and the second stop surface is fixedly positioned on the door stop.

14. The door hinge as defined in claim 8, wherein each of the knuckles has a substantially uniform knuckle diameter, and the door stop has a generally cylindrical outer diameter no more than 50% greater than a diameter of each of the knuckles.

15. A door hinge with an integral door stop for limiting pivoting motion of a door, the door hinge comprising:
a substantially planar door hinge plate secured to the door;
a substantially planar frame hinge plate secured to a door frame;
a plurality of door hinge knuckles each secured to the door hinge plate;
a plurality of frame hinge knuckles each secured to the frame hinge plate;
a hinge pin passing through an opening in each of the plurality of door hinge knuckles and the frame hinge knuckles; and
a door stop having an opening therethrough to receive the hinge pin, the door stop being rotationally movable with respect to each of the door hinge plate and the door frame plate, the door stop having a first stop surface for engagement with the door hinge plate when the door is open and a second stop surface for engagement with the frame hinge plate when the door is open.

16. The door hinge as defined in claim 15, wherein movement of the door stop in a direction during the axis the door pin is limited by the plurality of door hinge knuckles and frame hinge knuckles.

17. The door hinge as defined in claim 15, wherein the door stop comprises an upper body with lower teeth and a lower body with upper teeth, the mating teeth providing a selected circumferential spacing between the first stop surface and the second stop surface.

18. The door hinge as defined in claim 15, wherein each of the first planar surface and the second planar surface lie in a plane substantially parallel to an axis of the hinge pin.

19. The door hinge as defined in claim 15, wherein each of the first stop surface and the second stop surface is fixedly positioned on the door stop.

20. The door hinge as defined in claim 15, wherein each of the door hinge plate and the frame hinge plate include a plurality of plate apertures for securing each plate to a respective door and door frame.
